(19) United States
(12) Patent Application Publication
(10) Pub. No.: US 2010/0167140 A1
(43) Pub. Date: Jul. 1, 2010

(54) Response to Ingestion of Gas Into Fuel Cell Coolant

(76) Inventor: Ryan J. Balliet, West Hartford, CT (US)

Correspondence Address: M.P. Williams, 210 Main Street, Manchester, CT, 06042, US

(21) Appl. No.: 12/086,947

(22) PCT Filed: Dec. 30, 2005
(86) PCT No.: PCT/US2005/047567

§ 371 Date: Jun. 20, 2008

(51) Int. Cl. H01M 8/04

(52) U.S. Cl. 429/428

(57) ABSTRACT

A fuel cell power plant (9, 60) includes a plurality of fuel cells in a stack (10, 61) each having coolant channels (13, 64) with coolant outlets (27, 80) directed to a water gas separator (40, 77), a gas outlet (45, 82) being connected to an orifice (47, 84) through a pressure detector (46, 83). Detection of excessive pressure, indicative of excessive ingestion of gas into the coolant, causes a controller (39, 102) to control operating parameters of the fuel cell stack, such pressure or shutdown of coolant or reactant gas, to avoid fuel cell damage due to the gas ingestion.

### TECHNICAL FIELD

This invention relates to sensing the presence of excessive ingestion of gas in the coolant channels of a fuel cell stack, so that irreversible damage to the fuel cell stack may be avoided.

### BACKGROUND ART

In fuel cell stacks which utilize porous, at least partially hydrophilic reactant gas channel plates, which are variously referred to as “water transport plates” in some cases, bubble pressure is relied on to keep an interface between the gas (on the side of the reactant gas channels) and the water (on the side of the coolant channels). Bubble pressure is discussed in application publication US2004/0106034. If bubble pressure is lost, gas ingests into the coolant system at a rate which may be between 10 and 100 times greater than the normal rate of gas ingestion. The excessive gas in the coolant system may cause dryout of the proton exchange membrane, and possible failure thereof, reactant starvation, and system safety hazards.

### DISCLOSURE OF INVENTION

Aspects of the invention include: detecting excessive ingestion of gas into the coolant of fuel cell stacks; preventing irreversible damage due to gas ingestion in fuel cell stack coolant channels; improved PEM fuel cell power plants.

According to the present invention, a gas flow detector is disposed in line with a gas vent that vents a fuel cell stack coolant flow path. In further accord with the invention, in fuel cell stacks employing convection cooling with water circulating through the system and external heat exchanger, the gas flow detectors are disposed on an accumulator vent. In accordance with the invention further, in a cooled fuel cell stack with little or now flow of liquid out of the coolant channels, the gas flow detector sensor is disposed at a gas vent of the coolant channels.

According to the invention, the gas flow detectors may each comprise a pressure sensor between the coolant channel or accumulator gas vent and an orifice leading to ambient. Excessive pressure indicates excessive ingestion of gas into the coolant. The pressure sensor may be a simple pressure switch.

In systems employing the present invention, excessive gaseous flow from a vent through the orifice of the invention will create a substantial pressure drop, the increase of which is readily sensed so as to permit the controller to take measures to avoid damage to the system, such as shutting the power plant down or increasing the differential between the coolant water pressure and the pressure of reactant gases.

Other aspects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified, stylized, block diagram of a portion of a fuel cell power plant using convective cooling with circulating water flow and incorporating the present invention.

FIG. 2 is a simplified, stylized, block diagram of a portion of a fuel cell power plant employing evaporative cooling and incorporating the present invention.

### MODE(S) FOR CARRYING OUT THE INVENTION

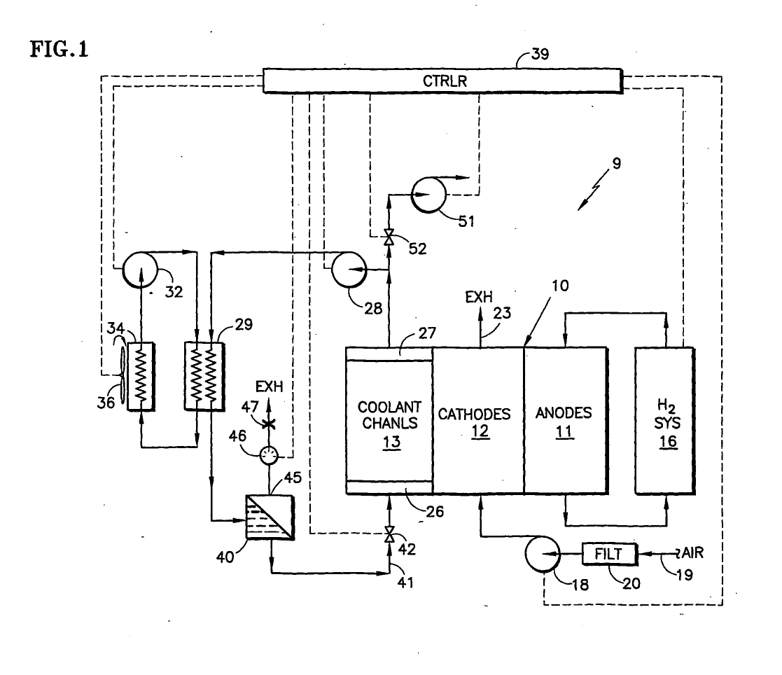

Referring to FIG. 1, a fuel cell power plant 9 includes a fuel cell stack 10 having anodes 11, cathodes 12 and coolant channels 13. The anodes 11 receive hydrogen from a hydrogen system 16 which may either supply a hydrogen-rich reformate gas or substantially pure hydrogen (such as commercial-grade hydrogen). There may be a fuel recycle loop and purging of the fuel channels, all as is conventional, the details of which do not affect the present invention.

In this embodiment, the cathodes 12 receive (as oxidant reactant gas) air from a pump 18 that is fed from ambient air 19 through a filter 20, in a conventional way. After passing through the oxidant reactant gas channels of the cathodes 12, the air is expelled to exhaust 23.

When the fuel cell stack is operating, water is continuously circulated through the coolant channels 13, from a coolant inlet 26 through the channels in each of the fuel cells, and thence through a coolant outlet manifold 27 to a coolant pump 28. The pump 28 draws the liquid through the coolant channels and passes it through a heat exchanger 29 where it may be cooled, when necessary, by exchange with a non-freezable liquid (such as polyethylene glycol) circulating through the heat exchanger 29 by means of a pump 32. The pump 32 draws the coolant through another heat exchanger 34 which is cooled by a fan 36, all of which is under the control of a controller 39.

The coolant flows from the heat exchanger 29 into a liquid air separator 40, the liquid being transmitted by a conduit 41 to the coolant inlet manifold 29 through a pressure control valve 42, which permits adjusting the pressure of the coolant in the coolant channels to assure proper bubble pressure, as described hereinbefore.

In accordance with the invention, the gas vent 45 of the separator 40 is connected to a pressure sensor 46, through an orifice 47 to exhaust (such as ambient). The pressure sensor may simply provide a signal indicative of pressure to the controller 39, or it may be a switch which either goes on or off as a function of a pressure deemed to be excessive, thereby indicating too much flow of gas through the orifice 47 and hence too much leakage into the coolant channels 13.

In response to determining from the pressure sensor 46 that the coolant channels are ingesting too much gas, the controller may respond in any of a number of ways, or in a combination of ways. For instance, the controller may simply shut the system down by causing the reactant flows to cease, in accordance with a conventional shutdown routine. On the other hand, the controller may adjust the relative pressure between the reactant gases in the anodes and cathodes and the water in the coolant channels 13. This may be achieved by adjusting the coolant channel water pressure by means of the valve 42 and/or the speed of the pump 28, or by adjusting pressure in the cathodes, by virtue of control over the pump, 18 along with adjusting hydrogen pressure within the hydrogen system 16.

In the general case, the pressure sensor 46 and orifice 47 comprise means for indicating to the controller 39 that there is excessive flow of gas through the vent, resulting from excessive ingestion of gas into the coolant within the coolant channels 13.

If desired in any implementation of the present invention, a coolant fill pump 51 may be utilized together with a control valve 52 in order to assist in refilling coolant channels if they are drained emanating from the coolant channels through the vent 82 so as to prevent freezing in cold climates.

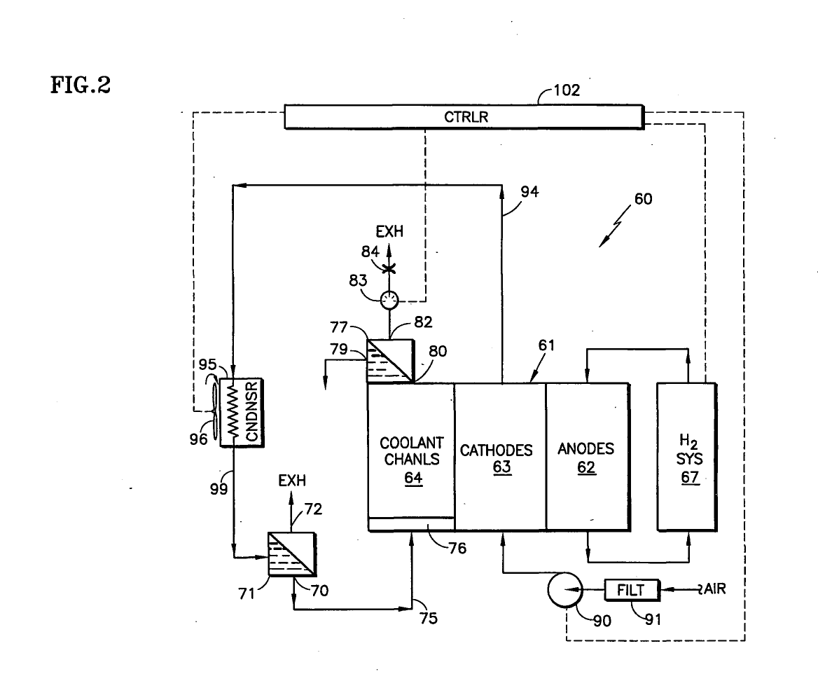

Another embodiment of the invention is illustrated in FIG. 2. Therein, a fuel cell power plant 60 includes a fuel cell stack 61 having anodes 62, cathodes 63 and coolant channels 64. A conventional hydrogen system 67 may provide relatively pure hydrogen or hydrogen-rich reformate gas to the anode 62. The nature of the hydrogen system 67 does not affect the present invention.

The fuel cell power plant 60 depicted in FIG. 2 is the type described in U.S. patent application Ser. No. 11/230,066 which employs evaporative cooling. Water is supplied to the coolant channels 64 from the liquid outlet 70 of a gas liquid separator 71, the gas outlet of which goes to exhaust (such as ambient) 72. The liquid flows through a connection 75 to a coolant inlet manifold 76, through the coolant channels 64, and into a gas liquid separator 77 at the outlets 80 of the coolant channels. The liquid outlet 79 of the separator goes to exhaust. The gas outlet 82 of the separator is connected to a pressure sensor 83 and through an orifice 84 to exhaust (such as ambient).

The coolant comes from evaporation of water from the cathode exhaust. The cathodes are fed air which is pumped by a pump 90 draws air through a filter 91 from ambient and feeds the air through the cathodes, the exhaust being applied by a conduit 94 to a condenser 95 which is cooled by a rotating fan 96. The condensate goes from the condenser outlet over a conduit 99 to the gas/liquid separator 71. The separated water leaves the exit 70, as described hereinbefore and flows over the conduit 75 to the coolant inlet manifold 76. The coolant inlet manifold 76 may comprise wicking, as is described in the aforementioned application; or it may simply comprise a manifold to interconnect all of the coolant channels with the water flow. As described in the aforementioned application, the amount of water in the system may be controlled with an overflow at a suitable point.

In the embodiment of FIG. 2, the pressure sensor 83 and orifice 84 sense, by means of pressure in this case, excessive flow of gas emanating from the coolant channels through the vent 82 and therefore excessive ingestion of gas into the coolant channels. In response, the controller 102 may take various steps in order to prevent irreversible damage to the fuel cells in the stack 61, as described with respect to FIG. 1 hereinbefore.

1. A method in a fuel cell power plant (9, 60), characterized by:
avoiding damage to fuel cells in a fuel cell stack (10, 61) within said fuel cell power plant by sensing (46, 47; 83, 84) excessive ingestion of gas into coolant channels (13, 64) of the fuel cells in said stack, and operating a controller (39, 102) in a manner to alter operational parameters within said fuel cell power plant so as to avoid damage to the fuel cells within said stack; and
said sensing comprises sensing excessive flow of gas from the coolant channels (13, 64) of the fuel cells by sensing excessive pressure across an orifice (47, 84) leading from outlets (27, 80) of said coolant channels (13, 64) to ambient.

2-3. (canceled)

4. A method according to claim 1 further characterized by:
said operating step comprises shutting down the power plant.

5. A method according to claim 1 further characterized by:
said operating step comprises increasing pressure differential between said coolant and reactant gases in said stack.

6. A fuel cell power plant (9, 60), comprising:
a plurality of fuel cells arranged in a stack (10, 61), said fuel cells having coolant channels (13, 64), fluid within said coolant channels exhausting from said coolant channels through a coolant outlet (28, 80); and
a controller for commanding the operational parameters of said fuel cell power plant;
characterized by:
means (48, 47; 83, 84) in fluid communication with said coolant channel outlet (22, 80) for determining presence of excessive ingestion of gas into coolant flowing within said coolant channels and providing a signal indication thereof, said controller responsive to said signal indication to alter the operating parameters of said fuel cell power plant In a manner to avoid damage to the fuel cells in said stack; and wherein
said means is configured to sense excessive flow of gas from the coolant channels (13, 64) of the fuel cells by sensing excessive pressure across an orifice (47, 84) leading from outlets (27, 80) of said coolant channels (13, 64) to ambient.

7-8. (canceled)

9. A fuel cell power plant (9, 60) according to claim 6 further characterized by:
said controller responsive to said signal indication to shut down said power plant.

10. A fuel cell power plant (9, 60) according to claim 6 further characterized by:
said controller responsive to Said signal indication to increase differential in pressure between said coolant and reactant gases in said stack.
